(19) United States
(12) Patent Application Publication
(10) Pub. No.: US 2009/0063530 A1
(43) Pub. Date: Mar. 5, 2009

(54) SYSTEM AND METHOD FOR MOBILE WEB SERVICE

(75) Inventors: Jihoon LEE, Bundang-gu (KR); Hai-Sung LEE, Seoul (KR); Jong-Oh KAHNG, Seoul (KR)

Correspondence Address: HAMMER & ASSOCIATES, P.C., 3125 SPRINGBANK LANE, SUITE G, CHARLOTTE, NC, 28226, US

(73) Assignee: LG Telecom Ltd.

(21) Appl. No.: 12/203,344

(22) Filed: Sep. 3, 2008

(30) Foreign Application Priority Data
Sep. 4, 2007 (KR) 10-2007-0089567
Aug. 11, 2008 (KR) 10-2008-0078482

(51) Int. Cl. G06F 7/00; G06F 15/16; G06F 17/30

(52) U.S. Cl. 707/101; 709/206; 707/E17.014

(57) ABSTRACT

A system and method for a mobile web service is provided. A system for a mobile web service includes: a generator parsing a web page to generate a text formatted first hierarchical structure tree; a converter encoding the generated first hierarchical structure tree to convert the encoded first hierarchical structure tree into a binary formatted second hierarchical structure tree; and a transmitter transmitting the converted second hierarchical structure tree to a mobile terminal.

### CROSS-REFERENCE TO RELATED APPLICATIONS

This application claims priority from Korean Patent Application No. 10-2007-0089567, filed on Sep. 4, 2007, and Korean Patent Application No. 10-2008-0078482, filed on Aug. 11, 2008, in the Korean Intellectual Property Office, the entire disclosures of which are incorporated herein by reference.

### BACKGROUND OF THE INVENTION

1. Field of the Invention

The present invention relates to a system and method for a mobile web service.

2. Description of Related Art

The new trend of digital convergence where all the information communication technologies are converged into a single device and service is currently the center of attention in the field of information technology (IT). Different types of media such as images, voice, data, and the like are readily converted without restriction on a terminal service network to thereby create a new service.

When a mobile phone was initially released in the market, only a function of making a voice call while a user is moving was emphasized. However, with the development of related technologies, new functions such as a scheduling function, a camera function, an MP3 player function, a mobile banking function, a satellite/terrestrial Digital Multimedia Broadcasting (DMB) function, a video call function, etc., have been added to the mobile phone. Currently, the functions are important factors when a user makes a decision for purchasing the mobile phone. Specifically, the mobile phone has become a daily necessity beyond a simple means for making a voice call.

Also, third-generation (3G) mobile communication services such as wireless broadband Internet (WiBro), wideband code division multiple access (WCDMA), high speed downlink packet access (HSDPA), etc., are currently commercialized, enabling a user to use a wireless Internet service via a mobile terminal. Therefore, when Internet service users desire to use an Internet service, as long as they have a mobile terminal, they are not required to visit a place with a personal computer (PC) and can use the Internet service at any place.

Accordingly, users have increasing concerns regarding a full browsing service that enables the users to use websites over wireless Internet services in the same format as a website viewed on a PC. The “full housing service” realizes a website in the same format as the website viewed on the PC, using a direct Internet connection to the mobile terminal such as a mobile phone. The full housing service denotes a service that enables mobile terminal users to directly input a Universal Resource Locator (URL) and access a wired website and thereby use all the Internet contents that can be viewed on the PC, beyond the range of contents that are provided by existing wireless portal websites.

Generally, the main customers of wireless Internet services are younger generations such as students, people first entering the workforce, etc., that is, usually teenagers to people in their thirties. A large number of the younger generations have their own homepage such as a blog and a mini homepage, and participate in Internet community activities using an Internet cafe. In addition, they generally send or receive information, greetings, etc., with their acquaintances using a guest book of the blog or mini homepage. When considering the above tendency, the available region of wireless Internet services may be more diversified.

### SUMMARY OF THE INVENTION

An aspect of the present invention provides a system and method for a mobile web service that can enhance a proxy server function to thereby reduce a data transmission amount, a data transmission time, etc. when browsing the Internet in a mobile environment, and also can improve web browsing speed in the mobile environment.

The present invention is not limited to the above purposes and other purposes not described herein will be apparent to those skilled in the art from the following description.

According to an aspect of the present invention, there is provided a system for a mobile web service, including: a generator parsing a web page, received from a web server in association with a request of a mobile terminal, to generate a first hierarchical structure tree; and a transmitter transmitting the generated first hierarchical structure tree to the mobile terminal.

According to another aspect of the present invention, there is provided a system for a mobile web service, including: a generator parsing a web page to generate a text formatted first hierarchical structure tree; a converter encoding the generated first hierarchical structure tree to convert the encoded first hierarchical structure tree into a binary formatted second hierarchical structure tree; and a transmitter transmitting the converted second hierarchical structure tree to a mobile terminal.

According to still another aspect of the present invention, there is provided a system for a mobile web service, including: a generator parsing a web page to generate a text formatted first hierarchical structure tree; a converter encoding the generated first hierarchical structure tree using a text compression scheme to convert the encoded first hierarchical structure tree into compressed text data; and a transmitter transmitting the converted compressed text data to a mobile terminal.

According to yet another aspect of the present invention, there is provided a system for a mobile web service, including: a generator parsing a web page to generate a binary formatted second hierarchical structure tree; and a transmitter transmitting the generated second hierarchical structure tree to a mobile terminal.

According to a further another aspect of the present invention, there is provided a system for a mobile web service, including: a receiver receiving a first hierarchical structure tree, generated by parsing a web page, from a proxy server in association with a request of the web page; and a rendering unit rendering the web page on a screen using the received first hierarchical structure tree.

According to still another aspect of the present invention, there is provided a system for a mobile web service, including: a receiver receiving a binary formatted second hierarchical structure tree from a proxy server in association with a request of a web page; and a rendering unit rendering the web page on a screen using the received second hierarchical structure tree.

According to still another aspect of the present invention, there is provided a method for a mobile web service, including: parsing a web page, received from a web server in association with a request of a mobile terminal, to generate a first hierarchical structure tree; and transmitting the generated first hierarchical structure tree to the mobile terminal.

According to still another aspect of the present invention, there is provided a method for a mobile web service, including: parsing a web page to generate a text formatted first hierarchical structure tree; encoding the generated first hierarchical structure tree to convert the encoded first hierarchical structure tree into a binary formatted second hierarchical structure tree; and transmitting the converted second hierarchical structure tree to a mobile terminal.

According to still another aspect of the present invention, there is provided a method for a mobile web service, including: parsing a web page to generate a text formatted first hierarchical structure tree; encoding the generated first hierarchical structure tree using a text compression scheme to convert the encoded first hierarchical structure tree into compressed text data; and transmitting the converted compressed text data to a mobile terminal.

According to still another aspect of the present invention, there is provided a method for a mobile web service, including: receiving a first hierarchical structure tree, generated by parsing a web page, from a proxy server in association with a request of the web page; and rendering the web page on a screen using the received first hierarchical structure tree.

According to still another aspect of the present invention, there is provided a method for a mobile web service, including: receiving a binary formatted second hierarchical structure tree from a proxy server in association with a request of a web page; and rendering the web page on a screen using the received second hierarchical structure tree.

Additional aspects, features, and/or advantages of the invention will be set forth in part in the description which follows and, in part, will be apparent from the description, or may be learned by practice of the invention.

### Effect of the Invention

According to embodiments of the present invention, it is possible to perform a parsing and encoding process via a proxy server and thereby reduce the size of data (binary formatted first document object model (DOM) tree) and transmit the reduced data to a mobile terminal.

According to embodiments of the present invention, it is possible to reduce the size of data and thereby reduce a data transmission amount and a data transmission time. Through this, it is possible to improve a web browsing speed in a mobile environment.

According to embodiments of the present invention, it is possible to receive a smaller amount of data than original data and render the received data, and thereby provide a satisfactory speed level for a user when the user accesses a website via a mobile terminal. Through this, it is possible to contribute to the advancement of a mobile web browsing service.

According to embodiments of the present invention, since a mobile terminal renders a web page to perform only a screen output, it is possible to improve a loading time of a web browser.

According to embodiments of the present invention, it is possible to improve a web browsing speed in a mobile environment and thereby enable a user to seamlessly use a website in the mobile environment.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating a network configuration of a system for a mobile web service according to an embodiment of the present invention;

FIG. 2 is a block diagram illustrating a configuration of a proxy server shown in FIG. 1;

FIG. 3 is a block diagram illustrating a configuration of a mobile terminal shown in FIG. 1;

FIG. 4 illustrates an example of a converting process between a first document object model (DOM) tree and a second DOM tree using a mapping table according to an embodiment of the present invention;

FIG. 5 is a flowchart illustrating a method for a mobile web service according to an embodiment of the present invention;

FIG. 6 is a flowchart illustrating a method for a mobile web service according to another embodiment of the present invention;

FIG. 7 illustrates an example of a DOM tree applied to embodiments of the present invention;

FIG. 8 illustrates an example of a DOM object applied to embodiments of the present invention;

FIG. 9 illustrates an example of a DOM property applied to embodiments of the present invention;

FIG. 10 illustrates an example of a DOM method applied to embodiments of the present invention; and

FIG. 11 illustrates an example of a tag and a value of a DOM object according to an embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

Prior to describing embodiments of the present invention, terms used throughout the present specification will be defined as follows:

A document object model (DOM) is an application programming interface (API) for documents formatted in Hypertext Markup Language (HTML), an eXtensible Markup Language (XML), etc. The DOM defines a logical structure of a document using a scheme of approaching and manipulating the document. The DOM is currently defined as a recommendation in World Wide Web Consortium (W3C) and is platform independent.

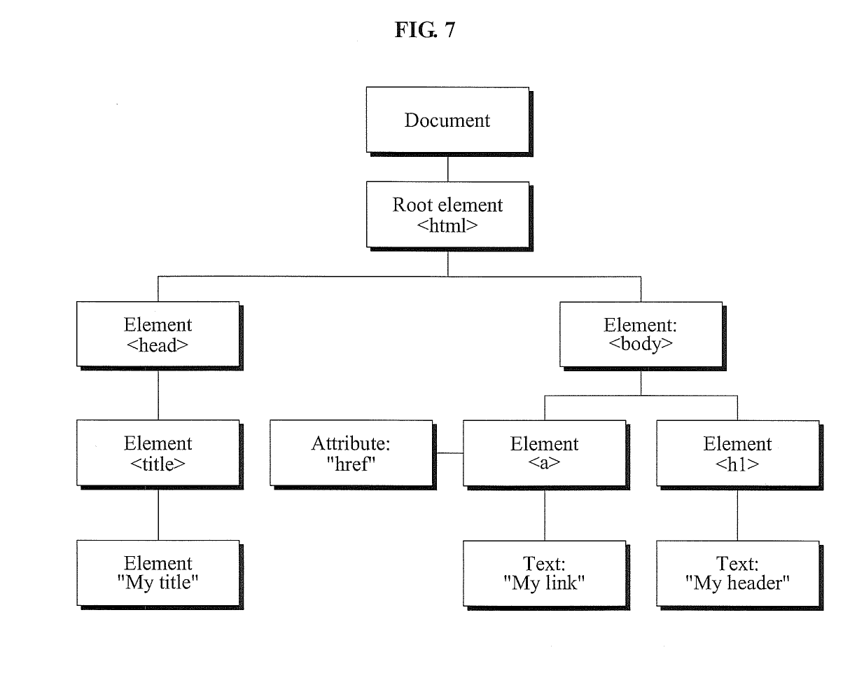

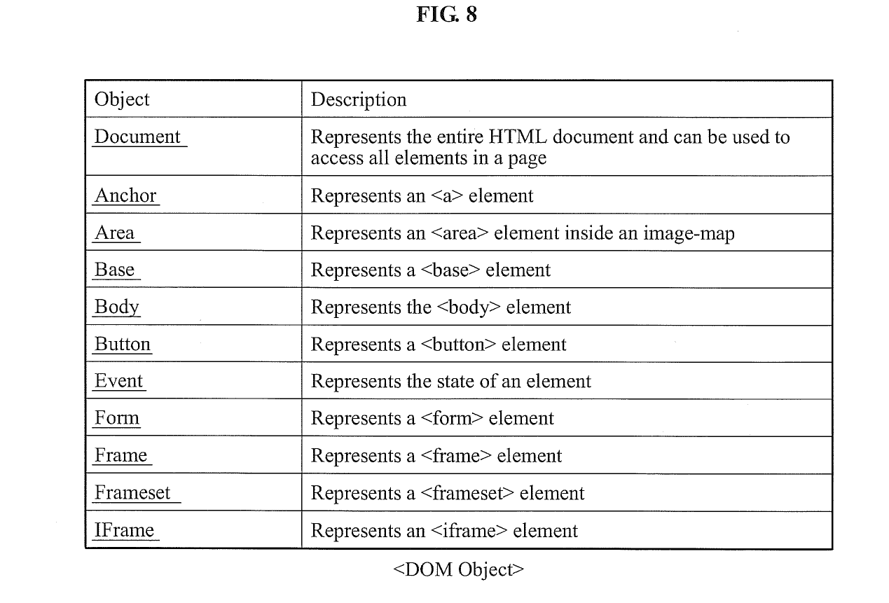

A DOM tree is expressed as a connection of nodes. The DOM tree starts from a root node to be extended to a lower node. FIG. 7 illustrates an example of the DOM tree applied to embodiments of the present invention. As shown in FIG. 7, the DOM tree starts from root node <html> to be extended to lower nodes <head>, <title>, <body>, and the like.

A DOM object denotes a node constituting the DOM tree and includes a DOM property and a DOM method. FIGS. 8 to 10 illustrate an example of the DOM object, the DOM property, and the DOM method applied to embodiments of the present invention.

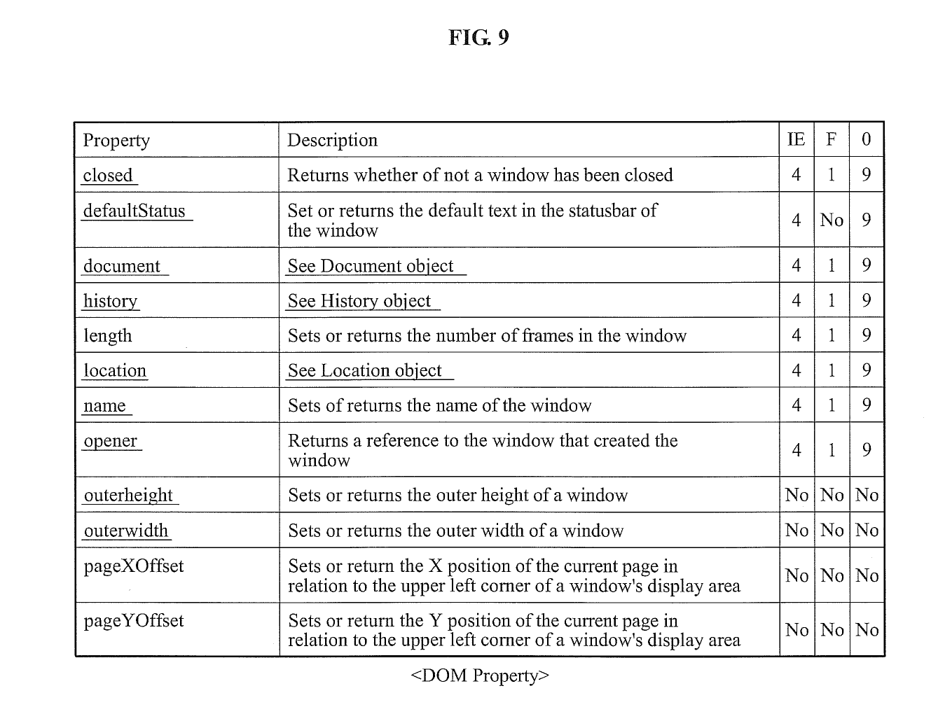

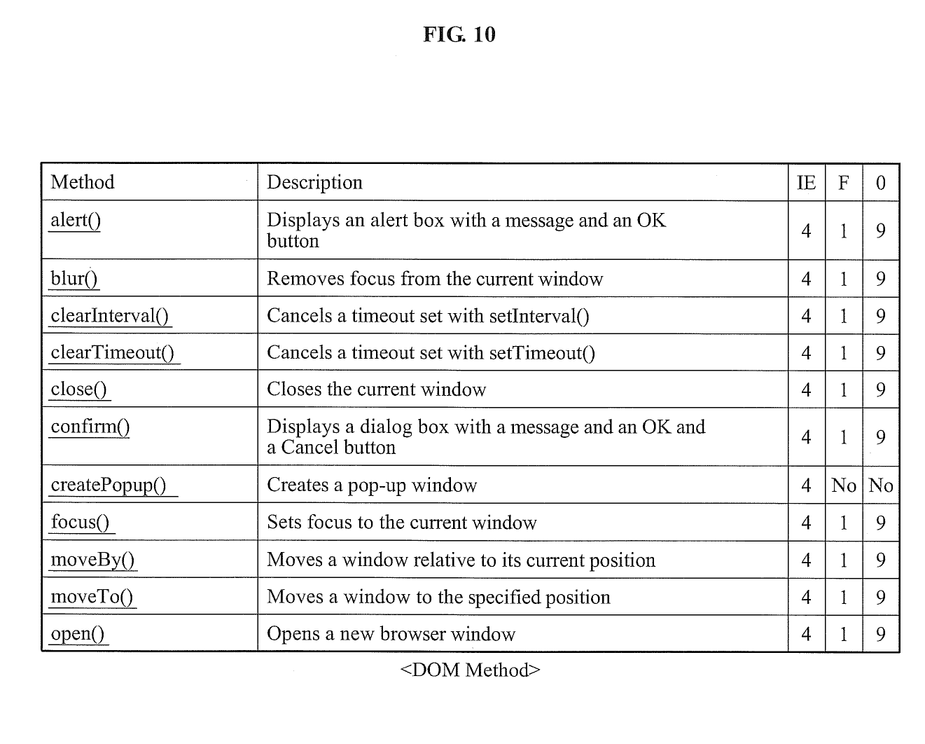

As shown in FIG. 8, the DOM object may include objects “Document”, “Anchor”, “Area”, “Base”, “Body”, and the like. As shown in FIG. 9, the DOM property may include properties “closed”, “defaultStatus”, “document”, “history”, “length”, and the like. As shown in FIG. 10, the DOM method may include methods “alert( )”, “blur( )”, “clearInterval( )”, “clearTimeout( )”, “close( )”, and the like.

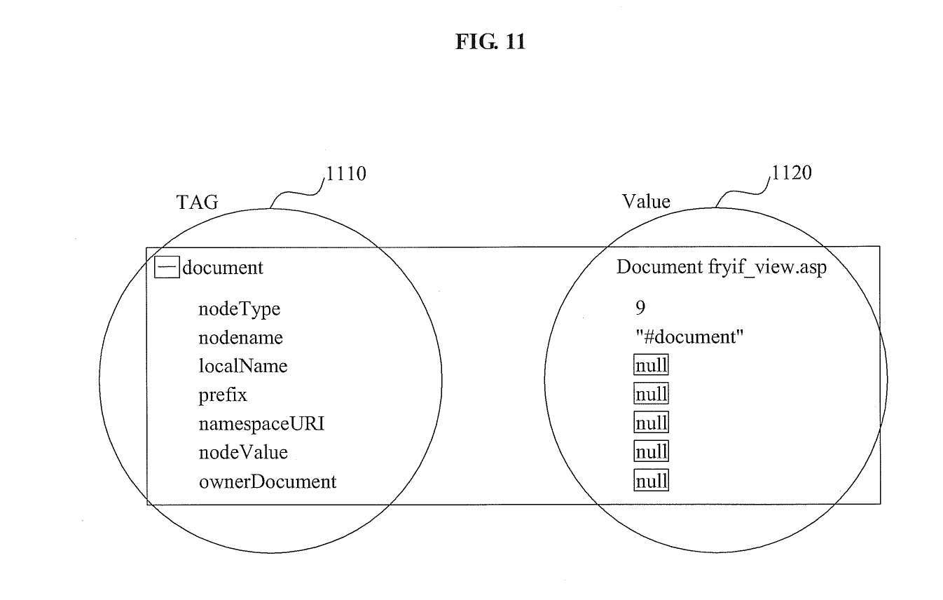

In this instance, all of the DOM object, the DOM property, and the DOM method may be expressed in the form of a tag and a value. The tag may be expressed as a string format. FIG. 11 illustrates an example of a tag and a value of the DOM object. As shown in FIG. 11, the DOM object may be expressed in the form of a tag 1110 and a value 1120, that is, “nodeType”—“9”, “nodename”—“#document”, “localName”—“null”, “prefix”—“null”, and the like.

Hereinafter, embodiments of the present invention will be described in detail with reference to the accompanying drawings.

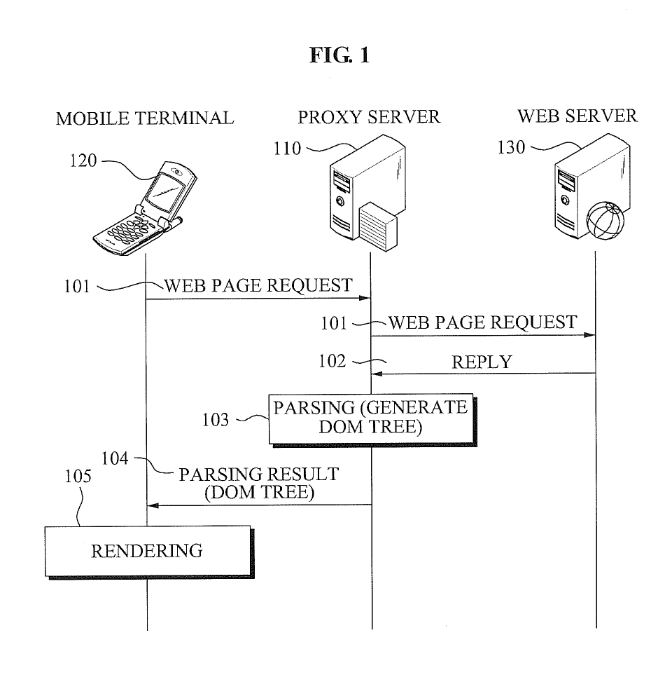

FIG. 1 illustrates a network configuration of a system for a mobile web service according to an embodiment of the present invention.

Referring to FIG. 1, the system for the mobile web service according to an embodiment of the present invention includes a proxy server 110, a mobile terminal 120, and a web server 130.

The proxy server 110 functions to receive a web page request 101 from the mobile terminal 120 and transfer the web page request 101 to the web server 130. The proxy server 110 may receive a corresponding web page from the web server 130 as a reply 102 to the web page request 101. The proxy server 110 may parse the received web page to generate a text formatted first hierarchical structure tree in operation 103.

The proxy server 110 may encode the generated first hierarchical structure tree to convert the encoded first hierarchical structure tree into a binary formatted second hierarchical structure tree. The proxy server 110 may transmit the converted second hierarchical structure tree, that is, a parsing result 104 to the mobile terminal 120.

When a user requests a new web page via input of a Uniform Resource Locator (URL) or link click in a mobile web browser that is installed in the mobile terminal 120, the mobile terminal 120 may transmit a web page request message for requesting the web page.

As reply to the web page request message, the mobile terminal 120 may receive the binary formatted second hierarchical structure from the proxy server 110. The mobile terminal 120 may render the web page on a screen using the received second hierarchical structure tree in operation 105.

The web server 130 functions to maintain the web page in a database. The web server 130 may receive the web page request message that is transmitted via the proxy server 110 from the mobile terminal 120. The web server 130 may search the database for a corresponding web page in correspondence to the received web page request message. The web server 130 may transmit the retrieved web page to the proxy server 110.

The first hierarchical structure tree and the second hierarchical structure tree may be understood as a concept that includes a DOM tree. Herein, the present invention will be described by limiting the first hierarchical structure tree to a first DOM tree and the second hierarchical structure tree to a second DOM tree. However, this is only for better comprehension and ease of description and thus the present invention is not limited thereto.

Hereinafter, a system for a mobile web service according to an embodiment of the present invention will be described in detail.

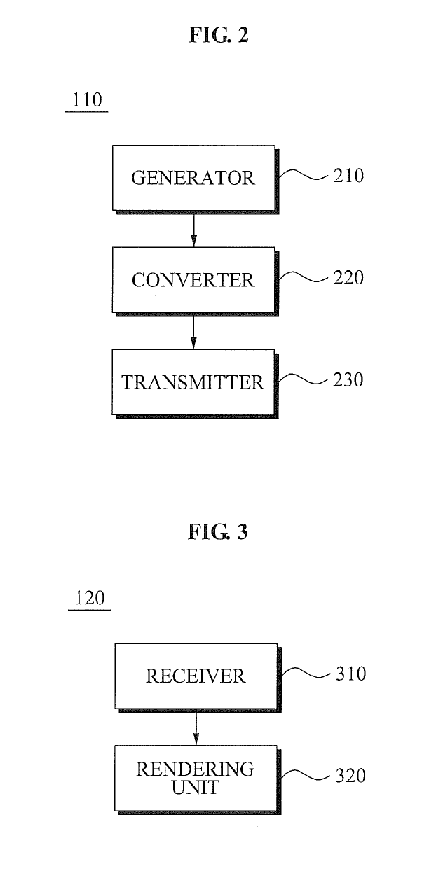

FIG. 2 is a block diagram illustrating a configuration of the proxy server 110 shown in FIG. 1.

Referring to FIGS. 1 and 2, the proxy server 110 includes a generator 210, a converter 220, and a transmitter 230.

When the web page is received from the web server 130 according to the web page request from the mobile terminal 120, the generator 210 may parse the received web page to generate a text formatted first DOM tree. The generator 210 may parse the received web page using a tree-based DOM scheme to generate the text formatted first DOM tree.

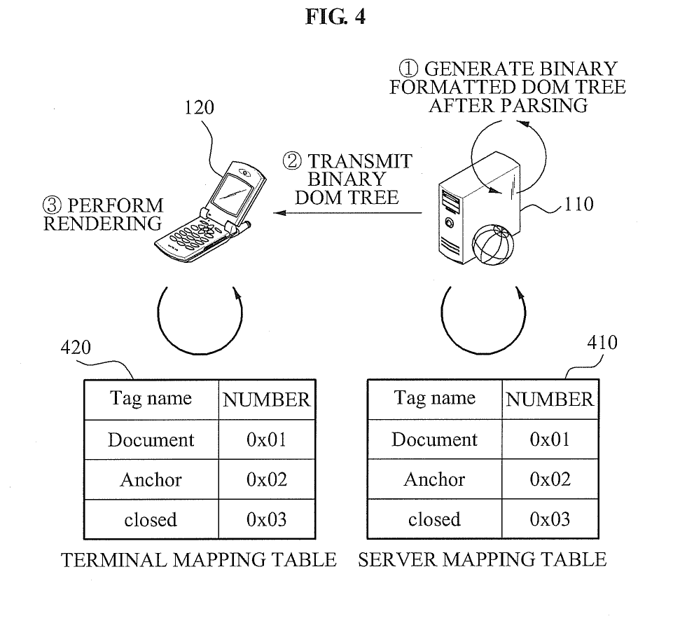

The converter 220 may encode the generated first DOM tree to convert the encoded first DOM tree into a binary formatted second DOM tree. Specifically, the converter 220 may convert a tag of the generated first DOM tree into a binary format using a server mapping table (see a table 410 of FIG. 4) to thereby convert the text formatted first DOM tree into the binary formatted second DOM tree.

For example, the converter 220 may convert tag names of a DOM object, a DOM property, and a DOM method that are included in the first DOM tree, into numbers respectively using the server mapping table to thereby convert the first DOM tree into the second DOM tree. Specifically, through a process of converting “Document” to “0x01”, “Anchor” to “0x02”, and “closed” to “0x03”, the converter 220 may convert the first DOM tree into the second DOM tree.

In this instance, it may be desirable that the converter 220 maintains the server mapping table to be the same as a terminal mapping table (see a table 420 of FIG. 4) of the mobile terminal 120. Specifically, the converter 220 may synchronize the server mapping table with the terminal mapping table for quick and accurate format conversion between the first DOM tree and the second DOM tree.

The transmitter 230 functions to transmit the converted second DOM tree to the mobile terminal 120. Also, the transmitter 230 may transmit the generated first DOM tree to the mobile terminal 120. Specifically, the transmitter 230 may transmit the generated first DOM tree to the mobile terminal 120 without converting the first DOM tree to the second DOM tree via the converter 220.

As described above, through a parsing and encoding process, the proxy server 110 may reduce the size of the first DOM tree to the size of the second DOM tree and transmit the reduced second DOM tree to the mobile terminal 120. Through this, it is possible to reduce a data transmission amount and a data transmission time and also improve a web browsing speed in a mobile environment.

According to another embodiment of the present invention, the proxy server 110 may include the generator 210, the converter 220, and the transmitter 230.

When the web page is received from the web server 130 according to the web page request from the mobile terminal 120, the generator 210 may parse the received web page to generate a text formatted first DOM tree. The generator 210 may parse the received web page using a tree-based DOM scheme to generate the text formatted first DOM tree.

The converter 220 may encode the generated first DOM tree using a text compression scheme to thereby convert the encoded first DOM tree into compressed text data. For example, the converter 220 may encode a tag, a character string, etc., of the object included in the generated first DOM tree using the text compression scheme to thereby convert the first DOM tree into the compressed text data.

As described above, the converter 220 may compress the first DOM tree using the text compression scheme to thereby reduce capacity of data. Through this, it is possible to reduce a data transmission amount and a data transmission time when transmitting data.

The transmitter 230 may transmit the converted compressed text data to the mobile terminal 120. Specifically, the transmitter 230 may transmit the converted compressed text data to a web browser of the mobile terminal 120.

Accordingly, the mobile terminal 120 may more quickly receive the compressed text data via the web browser. The mobile terminal 120 may decompress the compressed text data to restore the text data to original data, that is, the first DOM tree. The mobile terminal 120 may render the restored first DOM tree to thereby display the web page on a screen of the mobile terminal.

According to still another embodiment of the present invention, the proxy server 110 may include the generator 210 and the transmitter 230.

When the web page is received from the web server 130 according to the web page request from the mobile terminal 120, the generator 210 may parse the received web page to generate the binary formatted second DOM tree.

Specifically, the generator 210 may parse the received web page to the text formatted first DOM tree and process DOM objects included in the generated first DOM tree, into a binary format instead of a string format. Through this, the generator 210 may directly generate the binary formatted second DOM tree without an encoding process from the string format to the binary format.

During the process of parsing the received web page, the generator 210 may binarize the DOM objects of the first DOM tree and thereby directly generate the binary formatted second DOM tree without a separate encoding process.

For example, the generator 210 may perform a binary process for the DOM objects of the first DOM tree, that is, “Document”, “Anchor”, “closed, etc., into “0x01”, “0x02”, “0x03”, etc. to thereby generate the binary formatted second DOM tree without a separate encoding process using the converter 220.

The transmitter 230 may transmit the generated second DOM tree to the mobile terminal 120. In this instance, the transmitter 230 may transmit, to the mobile terminal 120, the second DOM tree that is converted into the binary format with a relatively smaller capacity than the text format, that is, the string format. Through this, it is possible to improve a data transmission time to the mobile terminal 120.

As described above, the proxy server 110 may reduce the data capacity in association with the web page to thereby improve the data transmission time to the mobile terminal 120. Through this, it is possible to improve a web browsing speed in a mobile environment.

According to yet another embodiment of the present invention, the proxy server 110 may include the generator 210 and the transmitter 230.

When the web page is received from the web server 130 according to the web page request from the mobile terminal 120, the generator 210 may parse the received web page to generate a text formatted first DOM tree. The generator 210 may encode the generated first DOM tree using a text compression scheme to convert the encoded first DOM tree into compressed text data.

For example, the generator 210 may encode all the data regarding a tag, a character string, etc., of objects included in the generated first DOM tree to thereby convert the first DOM tree into the compressed text data.

As described above, the generator 210 may compress the first DOM tree using the text compression scheme to thereby reduce the data capacity. Through this, it is possible to reduce a data transmission amount, a data transmission speed, and the like when transmitting data.

The transmitter 230 may transmit the compressed text data to the mobile terminal 120. Specifically, the transmitter 230 may transmit the converted compressed text data to a web browser of the mobile terminal 120.

Accordingly, the mobile terminal 120 may more quickly receive the compressed text data via the web browser. The mobile terminal 120 may decompress the received compressed text data to restore the text data to original data, that is, the first DOM tree. The mobile terminal 120 may render the restored first DOM tree to thereby display the web page on a screen of the mobile terminal 120.

Although not illustrated, the proxy server 110 may further include a cache management unit. The cache management unit may be applicable to all the aforementioned embodiments.

The cache management unit may retrieve in advance web pages that are highly probable to be requested again, from web pages previously requested from the mobile terminal 120, based on a number of requests, and the like. In this instance, the cache management unit may store the retrieved web pages in a cache using a hash table.

When a web page request is received from the mobile terminal 120, the cache management unit may inspect validity for the web pages stored in the cache. In this instance, the cache management unit may perform the validity inspection for the web pages by confirming properties of the web pages, for example, a date, a title, a description, a version, and the like.

When the web pages are verified to be valid through the above validity inspection, the cache management unit may retrieve a corresponding web page from the cache using the hash table and transfer the retrieved web page to the generator 210. In this instance, the cache management unit may provide a cache function using a prefetch. The prefetch denotes a scheme that reads various instructions to be sequentially executed while executing a current instruction, and thereby scheduling instructions.

In a case where image data is included in a web page when parsing the web page, the cache management unit may make a request for the image data, receive the image data, and store the received image data in the cache. When the image data is later requested, the cache management unit may further perform a pre-request function for converting or compressing the image data to transfer the converted or compressed image data. Through the above operation, the cache management unit may reduce a data transmission amount and improve a response speed with respect to the image data through conversion or compression of the image data, thereby improving a data transmission time.

FIG. 3 is a block diagram illustrating a configuration of the mobile terminal 120 of FIG. 1.

Referring to FIGS. 1 and 3, the mobile terminal 120 includes a receiver 310 and a rendering unit 320.

The receiver 310 functions to receive the binary formatted second DOM tree from the proxy server 110 in association with the web page request. Specifically, when the mobile terminal 120 requests the proxy server 110 for the web page, the receiver 310 may receive the second DOM tree from the proxy server 110.

As described above, the receiver 310 may receive the binary formatted second DOM tree with a relatively smaller data capacity than the text formatted first DOM tree, and thereby improving a data reception time from the web server 130. Also, since the receiver 310 reduces the data reception time and the like, it is possible to improve a web browsing speed in a mobile environment.

The rendering unit 320 functions to render the web page on a screen using the received second DOM tree. Specifically, the rendering unit 320 may decode the received second DOM tree to restore the second DOM tree to the text formatted first DOM tree. Also, the rendering unit 320 may render the web page on a screen of the mobile terminal 120 using the restored first DOM tree.

In this instance, the rendering terminal 320 may convert a tag of the received second DOM tree into a text format using the terminal mapping table (see the table 420 of FIG. 4). Specifically, the rendering unit 320 may decode the received second DOM tree based on the terminal mapping table to thereby restore the second DOM tree to the first DOM tree.

In this instance, it may be desirable that the rendering unit 320 maintains the terminal mapping table to be the same as the server mapping table (see the table 410 of FIG. 4) of the proxy server 110. This is to synchronize the terminal mapping table with the server mapping table and thereby enabling quick and accurate format conversion between the first DOM tree and the second DOM tree.

According to another embodiment of the present invention, the rendering unit 320 may directly render the second DOM tree without the conversion or decoding process to thereby display the web page on a screen of the mobile terminal 120.

Specifically, the rendering unit 320 may directly render binary data associated with DOM objects included in the second DOM tree to display the web page on the screen of the mobile terminal 120.

As described above, the mobile terminal 120 may receive, from the proxy server 110, and render the second DOM tree that is converted into a binary format. Therefore, when a user accesses a website, the mobile terminal 120 may provide the user with a satisfactory speed level and thereby contribute to the advancement of a mobile web browsing service.

Also, the mobile terminal 120 may receive and render data (web page) that is parsed or encoded by the proxy server 110 to thereby improve a loading time of a web browser. In addition, the mobile terminal 120 may realize quicker web browsing in a mobile environment, enabling the user to seamlessly use a website in the mobile environment.

According to still another embodiment of the present invention, the receiver 310 may receive compressed text data from the proxy server 110 in association with the web page request. Specifically, when the mobile terminal 120 requests the proxy server 110 for the web page, the receiver 310 may receive the compressed text data from the proxy server 110.

The rendering unit 320 may render the web page on the screen of the mobile terminal 120 using the received compressed data. Specifically, the rendering unit 320 may decode the compressed text data to thereby restore the text formatted first DOM tree and may also render the web page on the screen of the mobile terminal 120 using the restored first DOM tree.

Also, the receiver 310 may receive the first DOM tree, generated by parsing of a web page, from the proxy server 110 in association with a request of the web page. The rendering unit 320 may render the web page on a screen using the received first DOM tree.

As described above, since the mobile terminal 120 receives and renders data (compressed text data) with the relatively smaller capacity than the original data (first DOM tree), it is possible to improve a loading time of a web browser. Therefore, a user of the mobile terminal 120 may use a mobile web service at an improved speed.

FIG. 4 illustrates an example of a converting process between a first DOM tree and a second DOM tree using a mapping table according to an embodiment of the present invention.

Referring to FIG. 4, when parsing the text formatted first DOM tree, the proxy server 110 may convert the first DOM tree into the binary format using the server mapping table 410 to thereby generate the second DOM tree.

Specifically, the server mapping table 410 may include a tag name field including tag names and a number field including numbers to match the tag names respectively. By referring to the server mapping table 410, the proxy server 110 may convert the tag names of the first DOM tree, that is, tag names of a DOM object, a DOM property, and a DOM method, into numbers matching the tag names respectively.

For example, the proxy server 110 may convert, among the tag names of the first DOM tree, “Document” to “0x01”, “Anchor” to “0x02”, and “closed” to “0x03” by referring to the server mapping table 410.

As described above, the proxy server 110 may encode the first DOM tree with reference to the server mapping table 410 to thereby binarize the tag names of the first DOM tree and generate the binary formatted second DOM tree.

The proxy server 110 may transmit the generated second DOM tree to the mobile terminal 120. Since the proxy server 110 transmits the binarized second DOM tree, it is possible to reduce data overhead of the web page requested by the mobile terminal 120 and thereby improving a data transmission rate.

The mobile terminal 120 may receive the second DOM tree from the proxy server 110 and convert the received second DOM tree into the text format to thereby convert the second DOM tree into the first DOM tree. Specifically, the mobile terminal 120 may decode the second DOM tree using the terminal mapping table 420 to be the same as the server mapping table 410 and thereby decode tag names of the second DOM tree in numbers to text.

Specifically, the mobile terminal 120 may convert the tag names of the second DOM tree into the text format with reference to the terminal mapping table 420 to thereby restore the binary formatted second DOM tree to the text formatted first DOM tree.

For example, the mobile terminal 120 may convert, among the tag names of the second DOM tree, “0x01” to “Document”, “0x02” to “Anchor”, and “0x03” to “closed” by referring to the terminal mapping table 420.

As described above, the mobile terminal 120 may decode the second DOM tree with reference to the terminal mapping table 420 to thereby make the tag names of the second DOM tree in text and restore the first DOM tree.

The mobile terminal 120 may perform rendering using the restored first DOM tree to thereby display the web page on the screen of the mobile terminal 120.

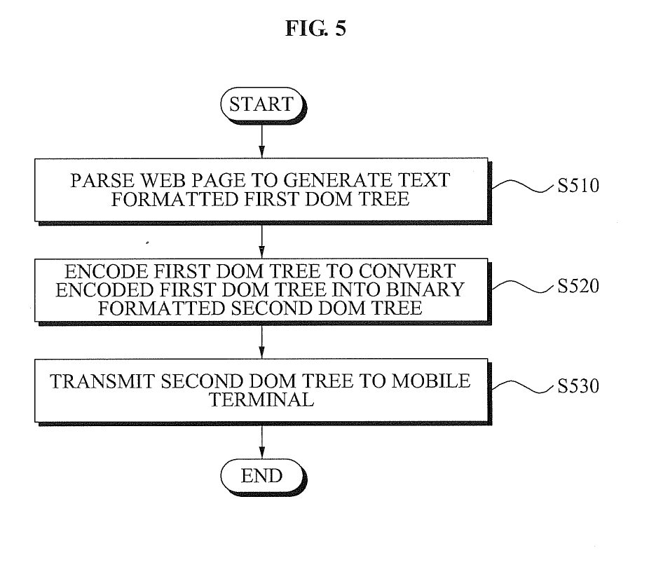

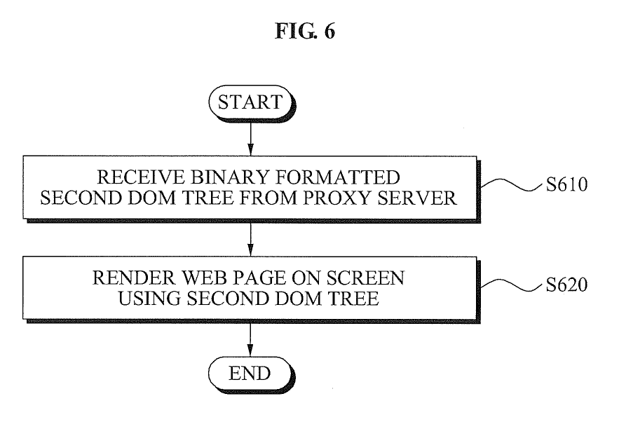

FIG. 5 is a flowchart illustrating a method for a mobile web service according to an embodiment of the present invention. The method for the mobile web service may be realized by a system for the mobile service according to an embodiment of the present invention. The system may be installed in the proxy server 110 of FIG. 1.

Referring to FIGS. 1 and 5, in operation S510, the system for the mobile web service may parse a received web page to generate a text formatted first DOM tree. In this instance, the system for the mobile web service may parse the received web page using a tree-based DOM scheme to generate the text formatted first DOM tree.

In operation S520, the system for the mobile web service may encode the generated first DOM tree to convert the encoded first DOM tree into a binary formatted second DOM tree. Specifically, the system for the mobile web service may convert a tag of the text formatted first DOM tree into a binary format using the server mapping table (see the table 410 of FIG. 4) to thereby convert the text formatted first DOM tree into the binary formatted second DOM tree.

For example, the system for the mobile web service may convert tag names of a DOM object, a DOM property, and a DOM method that are included in the first DOM tree, into numbers using the server mapping table to thereby convert the first DOM tree into the second DOM tree. Specifically, through a process of converting “Document” into “0x01”, “Anchor” into “0x02”, and “closed” into “0x03”, the system for the mobile web service may convert the first DOM tree into the second DOM tree.

In this instance, it may be desirable that the system for the mobile web service maintains the server mapping table to be the same as the terminal mapping table (see the table 420 of FIG. 4) of the mobile terminal 120. Specifically, the system for the mobile web service may synchronize the server mapping table with the terminal mapping table for quick and accurate format conversion between the first DOM tree and the second DOM tree.

In operation S530, the system for the mobile web service may transmit the converted second DOM tree to the mobile terminal 120.

As described above, through a parsing and encoding process the system for the mobile web service may reduce the size of the first DOM tree to the size of the second DOM tree and transmit the reduced second DOM tree to the mobile terminal 120. Through this, it is possible to reduce a data transmission amount and a data transmission time and also improve a web browsing speed in a mobile environment.

Also, after operation S510, the system for the mobile web service may encode the generated first DOM tree using a text compression scheme to thereby covert the encoded first DOM tree into compressed text data. For example, the system for the mobile web service may encode a tag, a character string, etc., of the object included in the generated first DOM tree using the text compression scheme to thereby convert the first DOM tree into the compressed text data.

As described above, the system for the mobile web service may compress the first DOM tree using the text compression scheme to thereby reduce capacity of data. Through this, it is possible to reduce a data transmission amount and a data transmission time when transmitting data.

Next, the system for the mobile web service may transmit the converted compressed text data to the mobile terminal 120. Specifically, the system for the mobile web service may transmit the converted compressed text data to a web browser of the mobile terminal 120.

According to another embodiment of the present invention, when the web page is received from the web server 130 according to the web page request from the mobile terminal 120, the system for the mobile web service may parse the received web page to generate the binary formatted second DOM tree.

Specifically, the system for the mobile web service may parse the received web page to the text formatted first DOM tree and process DOM objects included in the generated first DOM tree, into a binary format instead of a string format. Through this, the system for the mobile web service may directly generate the binary formatted second DOM tree without an encoding process from the string format to the binary format.

During the process of parsing the received web page, the system for the mobile web service may binarize the DOM objects of the first DOM tree and thereby directly generate the binary formatted second DOM tree without a separate encoding process.

For example, the system for the mobile web service may perform a binary process for the DOM objects of the first DOM tree, that is, “Document”, “Anchor”, “closed, etc., into “0x01”, “0x02”, “0x03”, etc. to thereby generate the binary formatted second DOM tree without a separate encoding process using the converter 220.

Next, the system for the mobile web service may transmit the generated second DOM tree to the mobile terminal 120. In this instance, the system for the mobile web service may transmit, to the mobile terminal 120, the second DOM tree that is converted into the binary format with a relatively smaller capacity than the text format, that is, the string format. Through this, it is possible to improve a data transmission time to the mobile terminal 120.

As described above, the system for the mobile web service may reduce the data capacity in association with the web page to thereby improve the data transmission time to the mobile terminal 120. Through this, it is possible to improve a web browsing speed in a mobile environment.

According to still another embodiment of the present invention, the system for the mobile web service may encode the generated first DOM tree using a text compression scheme to convert the encoded first DOM tree into compressed text data. For example, the system for the mobile web service may encode all the data regarding a tag, a character string, etc., of objects included in the generated first DOM tree to thereby convert the first DOM tree into the compressed text data.

As described above, the system for the mobile web service may compress the first DOM tree using the text compression scheme to thereby reduce the data capacity. Through this, it is possible to reduce a data transmission amount, a data transmission speed, and the like when transmitting data.

Next, the system for the mobile web service may transmit the compressed text data to the mobile terminal 120. Specifically, the system for the mobile web service may transmit the converted compressed text data to a web browser of the mobile terminal 120.

According to yet another embodiment of the present invention, the system for the mobile web service may retrieve in advance web pages that are highly probable to be requested again, from web pages previously requested from the mobile terminal 120, based on a number of requests, and the like. In this instance, the system for the mobile web service may store the retrieved web pages in a cache using a hash table.

Next, when a web page request is received from the mobile terminal 120, the system for the mobile web service may inspect validity for the web pages stored in the cache. In this instance, the system for the mobile web service may perform the validity inspection for the web pages by confirming properties of the web pages, for example, a date, a title, a description, a version, and the like.

Next, when the web pages are verified to be valid through the above validity inspection, the system for the mobile web service may retrieve a corresponding web page from the cache using the hash table.

Next, the system for the mobile web service may perform the aforementioned embodiments of the present invention using the retrieved web page. In this instance, the system for the mobile web service may provide a cache function using a prefetch.

In a case where image data is included in a web page when parsing the web page, the system for the mobile web service may make a request for the image data, receive the image data, and store the received image data in the cache.

When the image data is later requested, the system for the mobile web service may further perform a pre-request function for converting or compressing the image data to transfer the converted or compressed image data. Through the above operation, the system for the mobile web service may reduce a data transmission amount and improve a response speed with respect to the image data through conversion or compression of the image data, thereby improving a data transmission time.

FIG. 6 is a flowchart illustrating a method for a mobile web service according to another embodiment of the present invention. The method for the mobile web service may be performed by a system for the mobile web service according to another embodiment of the present invention. The system for the mobile web service may be installed in the mobile terminal 120 of FIG. 1.

Referring to FIGS. 1 through 6, in operation S610, the system for the mobile web service may receive the binary formatted second DOM tree from the proxy server 110 in association with the web page request. Specifically, when the mobile terminal 120 requests the proxy server 110 for the web page, the system for the mobile web service may receive the second DOM tree from the proxy server 110.

As described above, the system for the mobile web service may receive the binary formatted second DOM tree with a relatively smaller data capacity than the text formatted first DOM tree, and thereby improving a data reception time from the web server 130. Also, since the system for the mobile web service reduces the data reception time and the like, it is possible to improve a web browsing speed in a mobile environment.

In operation S620, the system for the mobile web service may render the web page on a screen using the received second DOM tree. Specifically, the system for the mobile web service may decode the received second DOM tree to restore the second DOM tree to the text formatted first DOM tree. Also, the system for the mobile web service may render the web page on a screen of the mobile terminal 120 using the restored first DOM tree.

In this instance, the system for the mobile web service may convert a tag of the received second DOM tree into a text format using the terminal mapping table (see the table 420 of FIG. 4). Specifically, the system for the mobile web service may decode the received second DOM tree based on the terminal mapping table to thereby restore the second DOM tree to the first DOM tree.

In this instance, it may be desirable that the system for the mobile web service maintains the terminal mapping table to be the same as the server mapping table (see the table 410 of FIG. 4) of the proxy server 110. This is to synchronize the terminal mapping table with the server mapping table and thereby enabling quick and accurate format conversion between the first DOM tree and the second DOM tree.

According to another embodiment of the present invention, the system for the mobile web service may directly render the second DOM tree without the conversion or decoding process to thereby display the web page on a screen of the mobile terminal 120.

Specifically, the system for the mobile web service may directly render binary data associated with DOM objects included in the second DOM tree to display the web page on the screen of the mobile terminal 120.

As described above, the system for the mobile web service may receive, from the proxy server 110, and render the second DOM tree that is converted into a binary format. Therefore, when a user accesses a website, the system for the mobile web service may provide the user with a satisfactory speed level and thereby contribute to the advancement of a mobile web browsing service.

Also, the system for the mobile web service may receive and render data (web page) that is parsed or encoded by the proxy server 110 to thereby improve a loading time of a web browser. In addition, the system for the mobile web service may realize quicker web browsing in a mobile environment, enabling the user to seamlessly use a website in the mobile environment.

According to still another embodiment of the present invention, the system for the mobile web service may receive compressed text data from the proxy server 110 in association with the web page request. Specifically, when the mobile terminal 120 requests the proxy server 110 for the web page, the system for the mobile web service may receive the compressed text data from the proxy server 110.

The system for the mobile web service may render the web page on the screen of the mobile terminal 120 using the received compressed data. Specifically, the system for the mobile web service may decode the compressed text data to thereby restore the text formatted first DOM tree and may also render the web page on the screen of the mobile terminal 120 using the restored first DOM tree.

As described above, since the system for the mobile web service receives and renders data (compressed text data) with the relatively smaller capacity than the original data (first DOM tree), it is possible to improve a loading time of a web browser. Therefore, a user of the mobile terminal 120 may use a mobile web service at an improved speed.

The mobile web service method according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for a mobile web service, comprising:
a generator parsing a web page, received from a web server in association with a request of a mobile terminal, to generate a first hierarchical structure tree; and
a transmitter transmitting the generated first hierarchical structure tree to the mobile terminal.

2. The system of claim 1, wherein the generator parses the web page according to a tree-based hierarchical structure scheme to generate the first hierarchical structure tree.

3. A system for a mobile web service, comprising:
a generator parsing a web page to generate a text formatted first hierarchical structure tree;
a converter encoding the generated first hierarchical structure tree to convert the encoded first hierarchical structure tree into a binary formatted second hierarchical structure tree; and
a transmitter transmitting the converted second hierarchical structure tree to a mobile terminal.

4. The system of claim 3, wherein the converter converts a tag of the generated first hierarchical structure tree into a binary format using a server mapping table.

5. The system of claim 4, wherein the converter maintains the server mapping table to be the same as a terminal mapping table of the mobile terminal.

6. The system of claim 3, wherein the generator parses the web page according to a tree-based hierarchical structure scheme to generate the first hierarchical structure tree.

7. A system for a mobile web service, comprising:
a generator parsing a web page to generate a text formatted first hierarchical structure tree;
a converter encoding the generated first hierarchical structure tree using a text compression scheme to convert the encoded first hierarchical structure tree into compressed text data; and
a transmitter transmitting the converted compressed text data to a mobile terminal.

8. A system for a mobile web service, comprising:
a generator parsing a web page to generate a binary formatted second hierarchical structure tree; and
a transmitter transmitting the generated second hierarchical structure tree to a mobile terminal.

9. The system of claim 8, wherein the generator parses the web page to generate a text formatted first hierarchical structure tree, processes objects included in the generated first hierarchical structure tree into a binary format to generate the second hierarchical structure tree.

10. A system for a mobile web service, comprising:
a receiver receiving a first hierarchical structure tree, generated by parsing a web page, from a proxy server in association with a request of the web page; and
a rendering unit rendering the web page on a screen using the received first hierarchical structure tree.

11. A system for a mobile web service, comprising:
a receiver receiving a binary formatted second hierarchical structure tree from a proxy server in association with a request of a web page; and
a rendering unit rendering the web page on a screen using the received second hierarchical structure tree.

12. The system of claim 11, wherein the rendering unit decodes the received second hierarchical structure tree to restore the decoded second hierarchical structure tree to a text formatted first hierarchical structure tree, and renders the web page on the screen using the restored first hierarchical structure tree.

13. The system of claim 11, wherein the rendering unit converts a tag of the received second hierarchical structure tree into a text format using a terminal mapping table.

14. The system of claim 13, wherein the rendering unit maintains the terminal mapping table to be the same as a server mapping table of the proxy server.

15. A system for a mobile web service, comprising:
a receiver receiving, from a proxy server, compressed text data in which a text formatted first hierarchical structure tree is compressed, in association with a request of a web page; and
a rendering unit decoding the received compressed text data to render the web page on a screen.

16. A method for a mobile web service, comprising:
parsing a web page, received from a web server in association with a request of a mobile terminal, to generate a first hierarchical structure tree; and
transmitting the generated first hierarchical structure tree to the mobile terminal.

17. A method for a mobile web service, comprising:
parsing a web page to generate a text formatted first hierarchical structure tree;
encoding the generated first hierarchical structure tree to convert the encoded first hierarchical structure tree into a binary formatted second hierarchical structure tree; and
transmitting the converted second hierarchical structure tree to a mobile terminal.

18. The method of claim 17, wherein the encoding comprises converting a tag of the generated first hierarchical structure tree into a binary format using a server mapping table.

19. The method of claim 18, wherein the encoding further comprises maintaining the server mapping table to be the same as a terminal mapping table of the mobile terminal.

20. The method of claim 17, wherein the parsing comprises parsing the web page according to a tree-based hierarchical structure scheme to generate the first hierarchical structure tree.

21. A method for a mobile web service, comprising:
parsing a web page to generate a text formatted first hierarchical structure tree;
encoding the generated first hierarchical structure tree using a text compression scheme to convert the encoded first hierarchical structure tree into compressed text data; and
transmitting the converted compressed text data to a mobile terminal.

22. A method for a mobile web service, comprising:
receiving a first hierarchical structure tree, generated by parsing a web page, from a proxy server in association with a request of the web page; and
rendering the web page on a screen using the received first hierarchical structure tree.

23. A method for a mobile web service, comprising:
receiving a binary formatted second hierarchical structure tree from a proxy server in association with a request of a web page; and
rendering the web page on a screen using the received second hierarchical structure tree.

24. The method of claim 23, wherein the rendering comprises:
decoding the received second hierarchical structure tree to restore the decoded second hierarchical structure tree to a text formatted first hierarchical structure tree; and
rendering the web page on the screen using the restored first hierarchical structure tree.

25. The method of claim 24, wherein the decoding and the restoring comprises converting a tag of the received second hierarchical structure tree into a text format using a terminal mapping table.

26. The method of claim 25, wherein the decoding and the restoring further comprises maintaining the terminal mapping table to be the same as a server mapping table of the proxy server.

27. A method for a mobile web service, comprising:
receiving, from a proxy server, compressed text data in which a text formatted first hierarchical structure tree is compressed, in association with a request of a web page; and
rendering the web page on a screen using the received compressed text data.
